(19) United States
(12) Patent Application Publication
(10) Pub. No.: US 2025/0076473 A1
(43) Pub. Date: Mar. 6, 2025

(54) TIME OF FLIGHT PATH DELAY COMPENSATION

(71) Applicant: STMicroelectronics International N.V., Marlow (GB)

(72) Inventor: John Kevin MOORE, Edinburgh (GB)

(73) Assignee: STMicroelectronics International N.V., Geneva (CH)

(21) Appl. No.: 18/239,558

(22) Filed: Aug. 29, 2023

(51) Int. Cl. G01S 7/4865; G01S 7/4863; G01S 17/10; G01S 17/894

(52) U.S. Cl. CPC G01S 7/4865; G01S 7/4863; G01S 17/10; G01S 17/894

(57) ABSTRACT

A time-of-flight (TOF) sensor includes a timing generator generating a timing reference, a first array of TOF-related components including rows of TOF-related components, with each row receiving the timing reference, and a dummy row of TOF-related components. The TOF sensor also includes a second array of TOF-related components including rows of TOF-related components, with each row receiving the timing reference, and a dummy row of TOF-related components. A first path delivers the timing reference to the rows of the first array, the first path passing from the timing generator, through the dummy row of TOF-related components in the second array, to the first array of TOF-related components. A second path delivers the timing reference to the rows of the second array, the second path passing from the timing generator, through the dummy row of TOF-related components in the first array, to the second array of TOF-related components.

### TECHNICAL FIELD

This disclosure is related to the field of optical sensing, and, in particular, to the equalizing of the response times of reference and return Single-Photon Avalanche Diode (SPAD) arrays in Time-of-Flight (TOF) sensors.

### BACKGROUND

Time-of-Flight (TOF) sensors are components utilized within various advanced technologies, playing a role in accurately measuring distances to targets. Applications for such TOF sensors span across multiple technical areas, including autonomous navigation for vehicles and drones, 3D mapping and imaging, virtual and augmented reality systems, gesture recognition in consumer electronics, and facial recognition in consumer electronics.

Direct Time-of-Flight (dTOF) sensors and Indirect Time-of-Flight (iTOF) sensors are two variants of TOF technology. A dTOF sensor works by emitting a short pulse of light towards a target and measuring the time it takes for the light to reflect off the target and return to the sensor. This approach yields an accurate measure of the distance to the target. On the other hand, an iTOF sensor operates by emitting a continuous wave of modulated light and measuring the phase shift between the emitted and the reflected light waves. While iTOF sensors can also calculate distances, they are typically less accurate than dTOF sensors for precise measurements, particularly over longer distances or in brightly lit environments. However, iTOF sensors tend to be more power-efficient and cheaper to produce, making them more desirable for certain applications such as arrays with high resolution such as VGA.

A dTOF sensor 10 is now described with reference to FIG. 1. The dTOF sensor 10 is embodied within a housing 11 that is partitioned into two chambers separated by an optical barrier 14: an outgoing chamber 12 and an incoming chamber 13.

Within the outgoing chamber 12, a Vertical-Cavity Surface-Emitting Laser (VCSEL) substrate 15 houses the VCSEL 16. The majority of the infrared laser beam produced by the VCSEL 16 forms an outgoing beam 17 directed towards a target object, while a portion of the infrared laser beam produced by the VCSEL 16 bounces off the interior of the housing 11 to form a reference beam 18. The reference laser beam 18 reflects off the interior of the housing 11 within the outgoing chamber 12 to strike a reference array of Single-Photon Avalanche Diodes (SPADs) 20, embedded within a substrate 19. These reference SPADs 20 detect the arrival of the reference beam 18, establishing a reference time-of-flight value. The optical barrier 14 prevents the outgoing beam 17 and reference beam 18 from reaching the incoming chamber 13.

The incoming chamber 13 houses an Infrared (IR) notch filter 22, which reduces the amount of ambient light which reaches the return array 21. Once through the IR notch filter 22, the return beam 23 strikes a return array of SPADs 21, also embedded within the substrate 19.

The operation of the dTOF sensor 10 involves a comparison of the time between the reference beam 18 striking the reference array of SPADs 20 and the outgoing beam 17 reaching the target, reflecting back, passing through the IR notch filter 22, and striking the return array of SPADs 21. This time duration is then converted to a distance based on the speed of light, which is constant.

Inherent in the operation of the time-of-flight calculation lies a potential challenge, namely the variability in response times of both the reference array of SPADs 20 and the return array 21. Once an incoming photon strikes a SPAD, it triggers the initiation of an avalanche breakdown, the generation of an electrical pulse, the detection of this pulse, and finally, the propagation of this signal through the readout circuitry, the output of which provides information on the phase difference between a timing reference and detections coming from the SPADs. These steps form the response time of a SPAD, with it being noted that delays resulting from the generation and propagation of the timing reference also form part of the response time.

This response time is, however, subject to potential variations, which can be due to process, voltage, and/or temperature changes within the SPADs. These fluctuations can inadvertently introduce discrepancies in the measured time of flight to the object (and discrepancies in the response time of the reference array). Note that this potential measurement error could be present even when the distance to the target object remains constant because such measurement errors may present as an offset, a fixed error applied to the TOF measurement regardless of the distance to the target. This measurement error or offset may change with process, voltage, or temperature.

Consider a scenario where the response time of the reference array 20 increases, while the response time of the return array 21 stays the same. In this case, even though the actual time of flight (from the VCSEL 16 to the object and back to the return array 21) has not changed, the differential time of flight (between the return and reference arrays) that the sensor 10 measures will decrease due to the increase in response time of the reference array 20. This could lead to a greater amount of offset. Such variability in response time thus presents a risk of undermining the accuracy of the distance measurements, a challenge that needs to be addressed to ensure consistent and reliable performance of the dTOF sensor 10. As such, further development is needed.

### SUMMARY

Disclosed herein is a time-of-flight (TOF) sensor that integrates a timing reference generator responsible for producing a timing reference signal. This sensor includes first and second arrays. The first array and a second array both contain multiple arrangements of TOF-related components, and each arrangement is designed to receive the timing reference signal. Additionally, both arrays feature a dummy arrangement of dummy TOF-related components.

The signal delivery mechanism to these arrays is structured via two specific paths. The first path facilitates the transmission of the timing reference signal to the first array's arrangements of TOF-related components, passing through the second array's dummy arrangements of TOF-related components. Conversely, the second path channels the timing reference signal to the arrangements of the second array, directing it through the dummy arrangement present in the first array.

The inclusion of dummy arrangements in both arrays provides for an equated response time across them. Either of the paths can potentially follow a snaking pattern. The first TOF-related components in the first array may be designed as photodiode based pixels belonging to a reference array. The second TOF-related components might be structured as photodiode based pixels of a return array, with the return array housing a larger number of arrangements than the reference array.

Each pixel in these arrays may include readout circuitry. The TOF sensor may include processing circuitry in the TOF sensor, which works in conjunction with the readout circuitries to provide for either direct or indirect time-of-flight testing. The first array's TOF-related components can be designed as single photon avalanche diode (SPAD) based pixels, while the second array's components may be Vertical Cavity Surface Emitting Laser diodes (VCSELs). Structurally, both arrays may organize their TOF-related components in rowed arrangements, with dummy components forming separate rows.

Also disclosed herein a method to drive the TOF sensor. The method begins with the generation of a timing reference signal. This signal undergoes routing through the first path, including of a dummy arrangement from the second array, and is then directed to the first array. Subsequently, the signal is channeled via the second path, moving through the first array's dummy arrangement, reaching the second array.

The TOF sensor may be used to gauge the distance to a specific target. This measurement technique may involve the emission of a laser beam, split into two distinct beams: an outgoing beam (reflecting from a target back to the second array) and an internal reference beam. The distance to the target is then inferred based on outputs from both arrays, either by tracking the time difference between the two beams' detections or by observing their phase variations.

### BRIEF DESCRIPTION OF THE DRAWINGS

FIG. 1 is a diagrammatical view of a prior art time of flight sensor.

FIG. 2 is a schematic block diagram of a time-of-flight sensor described herein that has balanced timing reference paths.

FIG. 2A is a schematic block diagram showing portions of the clock tree reference path, clock tree return path, drivers, reference array, and buffers of the reference array side of FIG. 2.

FIG. 2B is a schematic block diagram showing portions of the clock tree reference path, clock tree return path, drivers, reference array, and buffers of the return array side of FIG. 2.

FIG. 3 is a schematic block diagram of another time-of-flight sensor described herein that has balanced timing reference paths.

FIG. 4 is a schematic block diagram of yet another time-of-flight sensor described herein that has balanced timing reference paths.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

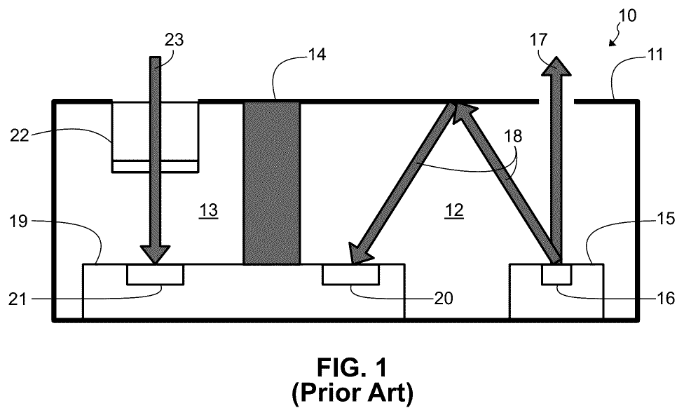

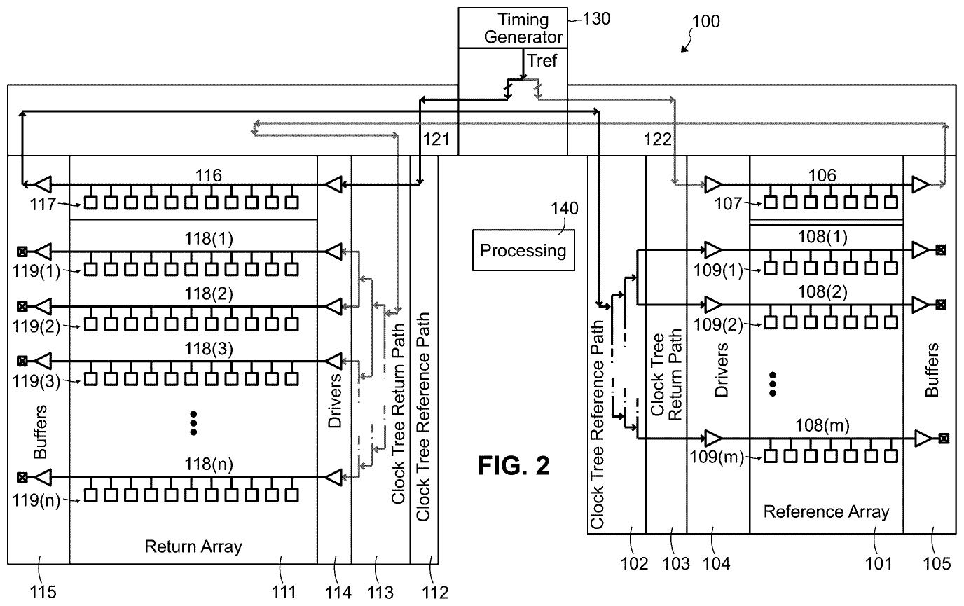

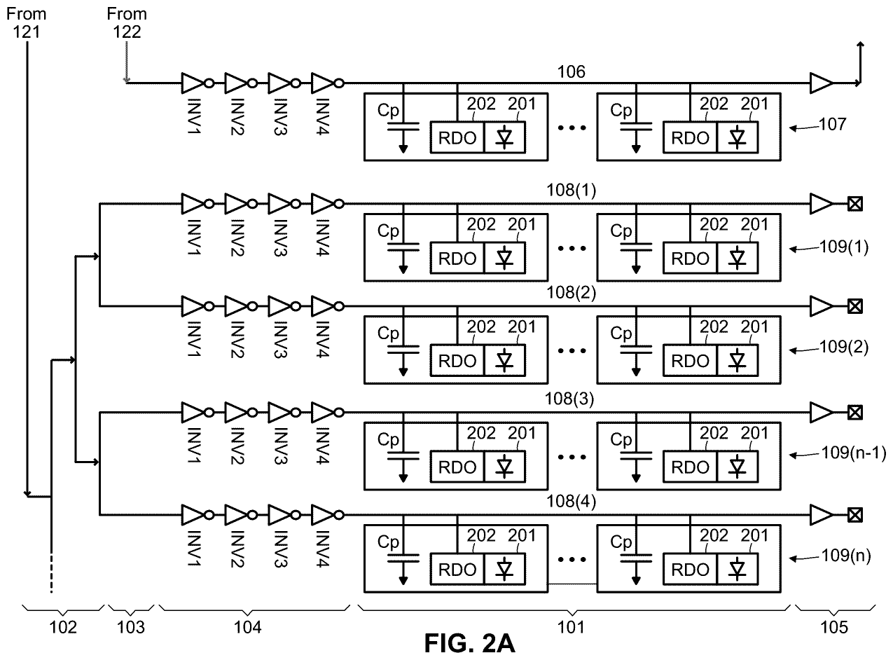

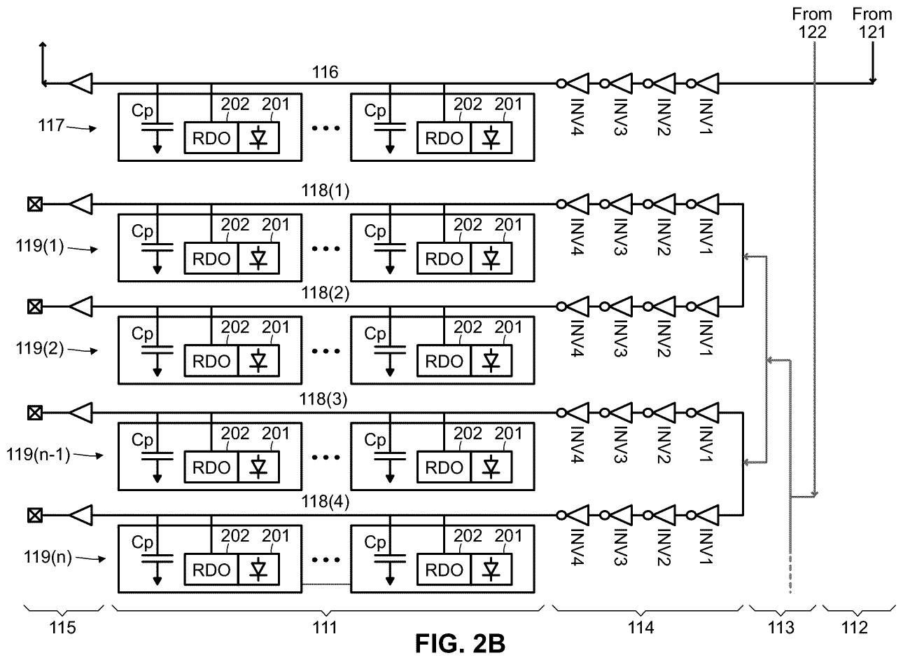

Now described with reference to FIG. 2 is a time-of-flight (TOF) sensor 100 including a reference array 101 and a return array 111. Note that, like the sensor 10 of FIG. 1, this TOF sensor 100 is disposed within a housing and has an optical barrier between the reference and return arrays. In fact, the TOF sensor 100 could be disposed within the housing 11 of the TOF sensor of FIG. 1, and may utilize the VCSEL 16 of FIG. 1 (or any suitable laser generator or LED) to emit a laser beam toward a target, with processing circuitry 140 within the sensor 100 functioning to determine the distance to the target based upon the time of flight of the laser beam to the target.

In greater detail, the reference array 101 includes rows 108(1), . . . , 108(m) of pixels 109(1), . . . , 109(m). As shown in FIG. 2A, these pixels 109(1), . . . , 109(m) each contain at least one single photon avalanche diode (SPAD) 201 that avalanches when struck by an incoming photon, effectively converting the photon strike event into an electrical signal that is read out by readout circuitry 202 within the pixels 109(1), . . . , 109(m). In the reference array 101, there is a row 106 of dummy pixels 107, each also including at least one SPAD 201 and associated readout circuitry 202. As also shown in FIG. 2A, each pixel 109(1), . . . , 109(m) and each dummy pixel 107 has a parasitic capacitance Cp associated therewith, leading to certain of the delays that this design seeks to balance.

The return array 111 includes rows 118(1), . . . , 118(n) of pixels 119(1), . . . , 109(n). As shown in FIG. 2B, these pixels 119(1), . . . , 119(m) each contain at least one single photon avalanche diode (SPAD) 201 that avalanches when struck by an incoming photon, effectively converting the photon strike event into an electrical signal that is read out by readout circuitry 202 within the pixels 119(1), . . . , 119(m). The return array 111 also includes a row 116 of dummy pixels 117, each also including at least one SPAD 201 and associated readout circuitry 202. The reference array 101 may be, for example, of the same dimensions or of smaller dimensions than the return array 111 and receives the reference beam reflected by the interior of the housing. In some embodiments, the reference array 101 is a multi-dimensional array, for example, having fewer rows and columns of pixels than the return array 111.

A timing reference signal Tref is generated by a timing generator 130. This timing reference signal Tref acts as a standardized start time against which photon detection events are measured, and is therefore utilized in time-of-flight calculations.

In operation, a Vertical-Cavity Surface-Emitting Laser (VCSEL), not shown, emits a coherent laser beam in the infrared spectrum, which forms an outgoing beam directed toward a target and a reference beam that reflects off the interior of the housing. Upon reflection from the target, the outgoing beam becomes a return beam, which is received by the return array 111. Concurrently, the reference beam bounces off the interior of the housing of the sensor 100 and is received by the reference array 101. The time of flight for each path is measured by taking the difference between the captured phase information of the return array 111 and the reference array 101. The timing reference signal Tref is utilized in the calculation of this time interval—for example, the timing reference signal Tref may begin counting when the laser beam is emitted by the VCSEL, and a difference between the count of the timing reference signal Tref at which the return beam is detected at the return array 111 and the count of the timing reference signal Tref at which the reference beam is detected at the reference array 101 may be determined. Since the speed of light is known, from this calculated difference the distance to the target may be determined.

Observe that the timing reference signal Tref is output along a reference path 121 and along a return path 122.

To reach the rows 108(1), . . . , 108(m) of the reference array 101, the timing reference signal Tref traverses the reference path 121 by passing, on the return array side, through the clock tree reference path 112, through driver 114 (e.g., multiple inverters INV1-INV4 in series), through the dummy row 116, and through buffer 115 to the reference array side. The reference path 121, on the reference array side, then passes through the clock tree reference path 102, which serves to distribute the timing reference signal Tref to the drivers 104 (e.g., multiple inverters INV1-INV4 in series). These drivers act as intermediaries between the clock tree 102 and the rows 108(1), . . . , 108(m) of pixels 109(1), . . . , 109(m) of the reference array 101. They receive the timing reference signal Tref and forward it directly to the rows 108(1), . . . , 108(m) of pixels 109(1), . . . , 109(m) of the reference array 101.

Likewise, to reach the rows 118(1), . . . , 118(m) of the return array 111, the timing reference signal Tref traverses the return path 122 by passing, on the reference array side, through the clock tree return path 103, through driver 104, through the dummy row 106, and through buffer 105 to the return array side. The reference path 122, on the return array side, passes through the clock tree return path 113, which serves to distribute the timing reference signal Tref to the drivers 114. These drivers 114 act as intermediaries between the clock tree 112 and the rows 118(1), . . . , 118(n) of pixels 119(1), . . . , 119(n) of the reference array 111. They receive the timing reference signal Tref and forward it directly to the rows 118(1), . . . , 118(n) of pixels 119(1), . . . , 119(n) of the return array 111.

By configuring the sensor 100 such that the timing reference signal Tref, which essentially acts as a standardized starting point for the TOF calculations, traverses through both the reference array 101 and return array 111, a balanced response time is achieved. This is because the timing reference signal Tref, whether destined for the reference array 101 or the return array 111, travels through both a dummy row 106 or 116 in the opposite array and the appropriate rows 108(1), . . . , 108(m) or 118(1), . . . , 118(n) of SPADs in its respective array. This helps ensure that both the reference array 101 and return array 111 are subject to the same influences from the propagation of the timing reference signal Tref, thereby harmonizing their response times.

This arrangement eliminates the variability that might be introduced if the timing reference signal Tref were to travel via two completely separate paths to the reference array 101 and return array 111. The variability could be due to factors like differences in the total length of the wiring, resistance, capacitance, and other parasitic effects. These variations could potentially introduce discrepancies in the measured times of flight, which would result in unwanted offset in the distance measurement. However, this dual-path, cross-over design negates these issues, thereby enhancing the accuracy and reliability of the TOF measurements.

In other words, if a shift in response time is encountered when the timing reference signal Tref passes through the dummy row in one array, the same shift will be imparted when the signal passes through the dummy row in the other array. This process effectively nullifies the relative discrepancy in the response times between the two arrays. As a result, even if the response time varies, this variation is consistently experienced by both arrays, ensuring that the difference between the measured time of flights remains consistent.

Furthermore, the paths 121 and 122 taken by the timing reference signal Tref can be modified in their structure to accommodate the need for specific response times or to provide for this balance. These paths may be direct and utilize blocks of layout with fixed parasitics to provide for balance or may snake through the circuitry, essentially adding additional distance to balance any potential delay in the signal propagation due to differences in circuit layout. An example of this is observable in FIG. 2, where the return path 122 on the return array side exhibits a snaking route. This flexibility in the design of the paths allows for further fine-tuning of the timing reference signal propagation, providing for accurate and consistent TOF calculations across different operating conditions.

This design of sensor 100 provides a robust solution to an inherent challenge in TOF sensors. By helping ensure that the response times across the reference array 101 and return array 111 are substantially uniform, the precision of the time-of-flight distance measurement is optimized, making this design particularly beneficial in applications where exact distance measurements are crucial.

In addition to the already discussed advantages, the design of the sensor 100 also aids in providing timing accuracy over varying voltages and temperatures. Response times can vary with changes in the operating voltage and temperature, potentially causing discrepancies in time-of-flight measurements. This is because the properties of electronic components can change with temperature and voltage, leading to changes in signal propagation times. However, by having the timing reference signal Tref traversing through both the reference array 101 and return 111, variations due to changes in voltage or temperature will affect both arrays in a similar manner, leading to a degree of self-compensation.

Moreover, the use of range offset trimming during testing is reduced. Trimming range offset during test is a time-consuming and costly process, involving calibrating the sensor at multiple points to account for variability in component properties. This calibration process is aimed at correcting inaccuracies in time-of-flight measurement. However, the design of the sensor 100, by providing for consistent response times across both the reference array 101 and return array 111, intrinsically minimizes these range offsets. Consequently, the need for range offset trimming during testing is reduced, leading to a reduction in test cost and complexity. This not only decreases the manufacturing expense but also makes the sensor more readily adoptable across different applications due to the reduced calibration requirements.

For example, the design of the sensor 100 in that the timing reference signal passes through both arrays (e.g., all arrays of the sensor) that feature more than two reference and return arrays. In scenarios where multiple spatial illuminations are employed, using multiple reference and return arrays can help capture more comprehensive data, thereby leading to more accurate and detailed measurements. By having the timing reference signal traverse each reference array and each return array, consistent timing may be maintained.

Moreover, this design can also accommodate the different paths that light may take when multiple spatial illuminations are used, by allowing the paths of the timing reference signal to be directed or snake through the different reference arrays and return arrays to balance delay. This provides for timing accuracy and reliability under more complex operational conditions, reducing the need for range offset trimming during testing, and improving the performance of advanced dTOF systems with multiple spatial illuminations.

While the sensor 100 has been described in the context of direct time-of-flight (dTOF) operation, the routing of the timing reference signal Tref as described above is also applicable to indirect time-of-flight (iTOF) designs.

In the same manner as dTOF sensing, iTOF sensing compares the time of arrival of light observed through a photodetector (generally a fast photodiode as opposed to a SPAD) vs a timing reference. iTOF techniques are therefore subject to the same offsets as dTOF techniques. iTOF designs could, therefore, also benefit from the use of a reference array in the same manner as dTOF designs and could also therefore benefit from the same timing compensation scheme descried hereinabove with respect to dTOF.

In iTOF designs that incorporate both reference and return arrays, the role of the timing reference signal is somewhat different than in dTOF systems, but also of interest. Instead of measuring the time that it takes for a short pulse of light to travel to a target and back, iTOF systems emit a continuous wave of modulated light and measure the phase shift between the emitted and reflected waves. This involves timing precision for accurate modulation and demodulation of the light signal. The design of the sensor 100, in which the timing reference signal Tref traverses both the reference array 101 and return array 111, helps to synchronize the modulation and demodulation processes. By maintaining consistent and precise timing across arrays, the phase shift can be accurately determined, leading to more reliable distance measurements. Like in dTOF designs, the architecture of the sensor 100 provides for timing accuracy over varying voltages and temperatures, and reduces the need for range offset trimming during testing, enhancing the performance and cost-effectiveness of iTOF systems.

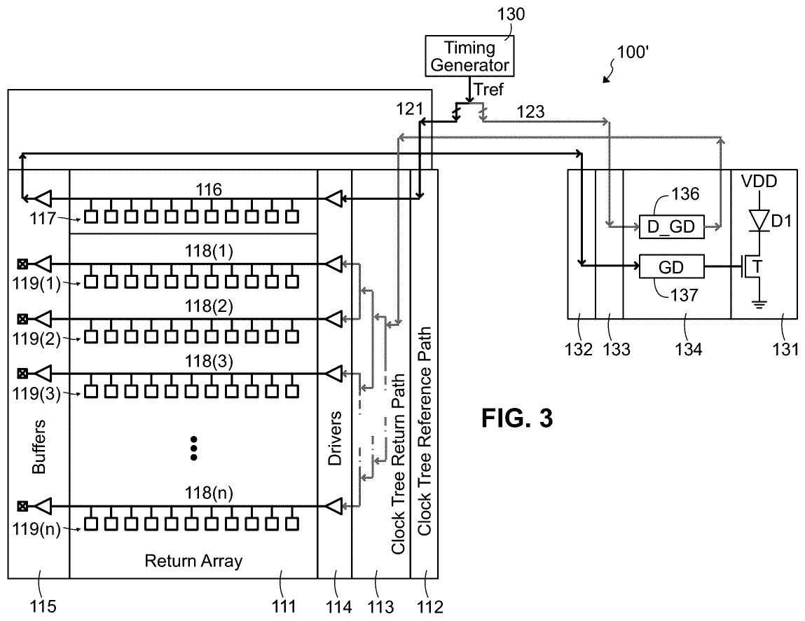

In another embodiment now described with reference to FIG. 3, a sensor design 100′ incorporates the return array 111 and its associated circuitry while eliminating the reference array 101 and its associated circuitry. Instead, this design utilizes a dummy path within a VCSEL array 131, as will be described below.

In operation, the timing reference signal Tref passes along path 121, proceeding through the dummy row 116 within the return array 111. After traversing the dummy row, it is then routed through a designated clock tree VCSEL path 132. Following this path, the timing reference signal Tref reaches the gate driver 137 housed within a driver section 134. This gate driver 137 is responsible for controlling the gate of a transistor T within the VCSEL array 131. The transistor T is in turn connected to the VCSEL D1, which has its anode connected to a positive voltage supply (VDD), its cathode connected to the transistor T's drain, and its source connected to ground.

The driver section 134 incorporates dummy gate drive circuitry 136. This circuitry is designed to mimic the delay through the gate driver 137. In a process parallel to that for driving the VCSELs, the timing reference signal Tref is routed along path 123, through the clock tree return path 133, and into the dummy gate drive circuitry 136. After this point, the timing reference signal Tref is routed back to the clock tree return path 113, where it passes into the drivers 114, and then finally into the rows 118(1), . . . , 118(n) of the return array 111.

This configuration provides for that the timing reference signal Tref traversing the return array, specifically through the dummy row 116 of SPADs, before it is used to drive the VCSELs, which emit the laser beam. The timing reference signal Tref also passes through the VCSEL array 131 before being passed into the return array 111. By having the timing reference signal Tref traverse the VCSEL array before reaching the return array 116, the timing for the photon emissions from the VCSELs is captured accurately. This is helpful as the time of these emissions is the starting point for the TOF measurements. Delay or variability in capturing this start time directly affects the accuracy of the TOF and the overall performance of the sensor 100′.

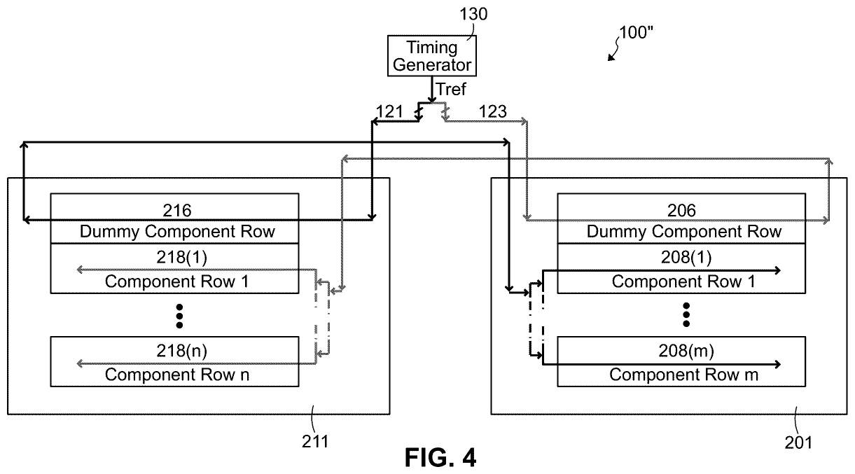

It is evident that modifications and variations can be made to what has been described and illustrated herein without departing from the scope of this disclosure. Indeed, the principles disclosed herein are applicable to any TOF sensor. A generic embodiment illustrating this is now described with reference to FIG. 4. This embodiment retains the timing reference generator 130, which generates the timing reference signal Tref, as well as the paths 121 and 123. In this embodiment, there are two arrays of TOF related components—a first array 201 and a second array 211.

The first array 201 comprises m rows 208(1), . . . , 208(m) of first TOF-related components. Additionally, the first array 201 includes a dummy row of components 206. Similarly, the second array 211 comprises n rows of second TOF-related components 218(1), . . . , 218(n), along with a dummy row of components 216.

The path of the timing reference signal Tref to the component rows 218(1), . . . , 218(n) of the second array 211 traverses along path 123. On its way, it passes through the dummy component row 206 of the first array 201. After that, it loops back around to the component rows 218(1), . . . , 218(n) in the second array 211.

Similarly, to reach the component rows 208(1), . . . , 208(m) of the first array 201, the timing reference signal Tref moves along path 121. It passes through the dummy component row 216 in the second array 211, and then snakes back around to reach the component rows 208(1), . . . , 208(m) in the first array 201.

This generalized embodiment illustrates that the concept of uniformly distributed response times introduced herein is applicable to any two TOF-related component arrays, not just arrays of SPADs or VCSELs. This uniform response time is due to the timing reference signal Tref traversing both the first array 201 and the second array 211, enabling a balanced delay to be achieved across both arrays by accounting for any inherent variability in the response times of the components of the arrays. This ultimately leads to a more accurate and reliable TOF sensor system that is versatile and adaptable to a wide array of applications.

Although this disclosure has been described with a limited number of embodiments, those skilled in the art, having the benefit of this disclosure, can envision other embodiments that do not deviate from the disclosed scope—for example, instead of being arranged into rows, the pixels may be arranged into columns, trees, or any other suitable arrangement. Furthermore, skilled persons can envision embodiments that represent various combinations of the embodiments disclosed herein made in various ways.

1. A time-of-flight (TOF) sensor, comprising:
a timing reference generator configured to generate a timing reference signal;
a first array of first TOF-related components, the first array including a plurality of arrangements of TOF-related components, with each arrangement receiving the timing reference signal, and a dummy arrangement of dummy TOF-related components;
a second array of second TOF-related components, the second array including a plurality of arrangements of TOF-related components, with each arrangement receiving the timing reference signal, and a dummy arrangement of dummy TOF-related components;
a first path configured to deliver the timing reference signal to the plurality of arrangements of the first array, the first path passing from the timing reference generator, through the dummy arrangements of dummy TOF-related components in the second array, to the first array of first TOF-related components; and
a second path configured to deliver the timing reference signal to the plurality of arrangements of the second array, the second path passing from the timing reference generator, through the dummy arrangement of dummy TOF-related components in the first array, to the second array of first TOF-related components.

2. The sensor of claim 1, wherein the first array and the second array resultingly have substantially uniform response times due to the traversal of the timing reference signal through the dummy arrangement of dummy TOF-related components in the first array and dummy arrangement of dummy TOF-related components in the second array.

3. The sensor of claim 1, wherein at least one of the first path and the second path follows a snaking route.

4. The sensor of claim 1, wherein the first TOF-related components are photodiode based pixels of a reference array; and wherein the first TOF-related components are photodiode based pixels of a return array, with the return array having more arrangements of TOF-related components than the reference array.

5. The sensor of claim 4, wherein each photodiode based pixel of the reference array includes readout circuitry; wherein each photodiode based pixel of the return array includes readout circuitry; and wherein the TOF sensor includes processing circuitry cooperating with the readout circuitries of the photodiode based pixels of the reference array and return array to perform direct time-of-flight testing.

6. The sensor of claim 4, wherein each photodiode based pixel of the reference array includes readout circuitry; wherein each phodotiode based pixel of the return array includes readout circuitry; and wherein the TOF sensor includes processing circuitry cooperating with the readout circuitries of the photodiode based pixels of the reference array and return array to perform indirect time-of-flight testing.

7. The sensor of claim 4, wherein the first TOF-related components are single photon avalanche diode (SPAD) based pixels of a reference array; and wherein the first TOF-related components are SPAD based pixels of a return array, with the return array having more arrangements of TOF-related components than the reference array.

8. The sensor of claim 1, wherein the first TOF-related components are photodiodes of a reference array; and wherein the second TOF-related components are optical sources.

9. The sensor of claim 8, wherein the first TOF-related components are single photon avalanche diodes (SPADs) of a reference array; and wherein the second TOF-related components are Vertical Cavity Surface Emitting Laser diodes (VCSELs).

10. The sensor of claim 1, wherein the plurality of arrangements of TOF-related components of the first array comprise a plurality of rows of TOF-related components; wherein the dummy arrangement of dummy TOF-related components of the first array comprises a dummy row of TOF-related components; wherein the plurality of arrangements of TOF-related components of the second array comprise a plurality of rows of TOF-related components; wherein the dummy arrangement of dummy TOF-related components of the second array comprises a dummy row of TOF-related components.

11. A method for operating a time-of-flight (TOF) sensor, the method comprising:
generating a timing reference signal;
passing the timing reference signal through a first path that includes a dummy arrangement within a second array of second TOF-related components;
delivering the timing reference signal to a first array of first TOF-related components after passage of the timing reference signal through the first path;
passing the timing reference signal through a second path that includes a dummy arrangement of the first array; and
delivering the timing reference signal to the second array after passage of the timing reference signal through the second path.

12. The method of claim 11, further comprising measuring distance to a target utilizing the TOF sensor.

13. The method of claim 11, wherein the distance to the target is measured by:
generating a laser beam using at least one optical source;
splitting the laser beam into: an outgoing beam directed toward the target such that the outgoing beam reflects off the target to return to the second array of second TOF-related components as a return beam, the second TOF-related components being photodiode based pixels; and a reference beam that reflects off an interior of the TOF sensor to return to the first array of first TOF-related components, the first TOF-related components being photodiode based pixels; and
determining the distance to the target based upon output from the first array and the second array.

14. The method of claim 13, wherein the distance to the target is determined based upon output from the first array and the second array by measuring an elapsed time between detection of the reference beam by the first array and detection of the return beam by the second array.

15. The method of claim 13, wherein the distance to the target is determined based upon output from the first array and the second array by measuring phase difference between the reference beam as detected by the first array and the return beam as detected by the second array.

16. The method of claim 11, wherein the distance to the target is measured by:
generating a laser beam using at least one Vertical Cavity Surface Emitting Laser diode (VSEL);
splitting the laser beam into: an outgoing beam directed toward the target such that the outgoing beam reflects off the target to return to the second array of second TOF-related components as a return beam, the second TOF-related components being single photon avalanche diode (SPAD) based pixels; and a reference beam that reflects off an interior of the TOF sensor to return to the first array of first TOF-related components, the first TOF-related components being SPAD based pixels; and
determining the distance to the target based upon output from the first array and the second array.
